(19) United States
(12) Patent Application Publication
(10) Pub. No.: US 2021/0248360 A1
(43) Pub. Date: Aug. 12, 2021

(54) ENTITY DETECTION WITHIN IMAGES

(71) Applicant: QUALCOMM Incorporated, San Diego, CA (US)

(72) Inventor: Edwin Chongwoo PARK, San Diego, CA (US)

(21) Appl. No.: 16/784,095

(22) Filed: Feb. 6, 2020

(51) Int. Cl. G06K 9/00; G06K 9/20

(52) U.S. Cl. CPC G06K 9/00362; G06K 9/00744; G06K 9/2054

(57) ABSTRACT

Methods, systems, computer-readable media, and apparatuses for entity detection within images are presented. One example method includes receiving an image of a scene; detecting one or more bodies within the image; determining one or more regions within the image based on the detected one or more bodies; detecting one or more heads within the one or more regions; and determining entities within the one or more regions based on the detected one or more heads.

### BACKGROUND

Images of groups of people may be captured in a wide variety of settings, such as by security cameras, video cameras at sporting events, etc. The number of people captured within a particular image may be determined by manually counting the people visible within the image.

### BRIEF SUMMARY

Various examples are described for entity detection within images. One example method includes receiving an image of a scene; detecting one or more bodies within the image; determining one or more regions within the image based on the detected one or more bodies; detecting one or more heads within the one or more regions; and determining entities within the one or more regions based on the detected one or more heads.

One example device includes a non-transitory computer-readable medium; and a processor communicatively coupled to the non-transitory computer-readable medium and configured to execute processor-executable instructions stored in the non-transitory computer-readable medium, the processor-executable instructions configured to cause the processor to receive an image of a scene; detect one or more bodies within the image; determine one or more regions within the image based on the detected one or more bodies; detect one or more heads within the one or more region; and determine entities within the one or more regions based on the detected one or more heads.

One example non-transitory computer-readable medium includes processor-executable instructions configured to cause a processor to receive an image of a scene; detect one or more bodies within the image; determine one or more regions within the image based on the detected one or more bodies; detect one or more heads within the one or more region; and determine entities within the one or more regions based on the detected one or more heads.

One example apparatus includes means for receiving an image of a scene; means for detecting one or more bodies within the image; means for determining one or more regions within the image based on the detected one or more bodies; means for identifying one or more heads within the region; and means for determining entities within the one or more region based on the identified one or more heads.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-3 show example systems for entity detection within images;

FIGS. 4A-4C and 5 show example images for use with example systems and methods for entity detection within images;

FIG. 6 shows an example method for entity detection within images;

FIG. 7 shows an example computing device for entity detection within images; and

FIG. 8 illustrates an example of a camera suitable for use with examples according to this disclosure.

### DETAILED DESCRIPTION

Examples are described herein in the context of entity detection within images. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Detecting entities, e.g., people, within a captured image can be a difficult exercise, including for a computing device. If there are a large number of people in the image, some may be partially obscured by other people within the image, and if the image is taken at a distance from the people, they each may appear small and some may seem to blend together. However, knowing the number of entities within an image may be useful in some settings. For example, if the entities are livestock, e.g., cows, sheep, chickens, etc., it may help a farmer or rancher keep track of their herd or flock. If the entities are people, it may help determine how many people are in attendance at an event or are travelling through a subway station at a particular time.

To illustrate an example way to determine a number of entities within an image, a computing system receives video from a camera overlooking an outdoor area. The computing system then selects a frame from the video to analyze and obtains that frame as an image. For example, the computing system may sample the video at a predetermined rate of one frame per second.

The computing system then analyzes the image to identify one or more entity bodies within the image. At this phase, the computing system employs a body recognition algorithm to identify one or more regions that likely include a body, but the recognition algorithm need not be completely accurate. Instead, the recognition algorithm employs a relatively low confidence threshold, e.g., 50-75%, when determining whether a body is present at a particular location within the image. The goal of this step is to reduce the area within the image to look for individual entities. Regions that likely have bodies within them are identified for further processing, while regions that likely do not have bodies within them may then be excluded. By employing a relatively low confidence threshold, the computing system is likely to identify all regions with entities within them, even if some false positives occur.

After the body recognition algorithm has identified likely entity bodies within the image, the computing device identifies regions within the image that include all of those bodies. In this example, the computing device creates one or more bounding boxes to establish the regions. The image data within each of these bounding boxes is then provided to a head recognition algorithm, which identifies any entity heads within each bounding box. The head recognition algorithm is trained to recognize the heads of the particular entities expected to be found in the images processed by the computing system, e.g., humans. Because the image information supplied to the head recognition algorithm has already been identified as likely having one or more entity bodies within it, the head recognition algorithm can operate with a relatively high confidence threshold, e.g., 95% or greater, since one or more heads are likely to be found in the identified regions, i.e., the system is fairly confident that one or more heads will be found, and to avoid false positives for artifacts within the image that may resemble a head but are not.

After the head recognition algorithm has been executed on each of the regions of the image within a bounding box, the computing system counts the number of identified heads. It then removes any excess head counts from overlapping bounding boxes, and provides the final head count for the image. After providing the final head count, the computing system can then process additional images from the video.

The example algorithm discussed above performs a two-stage analysis to detect and count entities within an image. It first performs a search for likely entity bodies within the image to identify regions within which to look for heads of the entities. By then searching for entity heads, the system is able to identify individual entities without the need to resolve overlaps between entities within the image, partially obscured entities, or entities of different shapes or sizes. Instead, each entity is expected to have a head. However, simply searching for heads within an image is prone to misidentification. Because heads tend to have shapes similar to non-head objects, e.g., anything round in the case of a human, either false positives occur frequently or a confidence level threshold is set high enough that true matches may be discarded.

Further, by relying on identifying heads to identifies entities within an image, processing requirements can be significantly reduced. More generalized entity recognition algorithms may scan an image pixel by pixel and attempt to identify an object that each pixel is associated with, which involves detecting overlapping objects, etc., and identifying the respective individual objects. This can be extremely computationally expensive. In addition, oftentimes when there are people near each other, there is occlusion that limits the detectability of individual entities, even by such object recognition algorithms. Further, within an area where multiple people are in close proximity to each other, some algorithms may interpret overlapping entities to be a single entity and therefore not detect every entity in the image. In addition to these difficulties, such algorithms may only detect entities in a certain pose, e.g., facing the camera, and thus multiple algorithms may need to be employed to detect entities having arbitrary poses within the image.

By instead performing an initial pass using a low-complexity entity detector to identify likely regions with entity bodies, followed by a high-confidence pass to identify heads within the identified regions, complexities associated with differentiating entities within the image from each other at the pixel level can be avoided. Thus, much less sophisticated processing equipment, such as a handheld smartphone, may perform accurate entity detection.

This illustrative example is given to introduce the reader to the general subject matter discussed herein and the disclosure is not limited to this example. The following sections describe various additional non-limiting examples and examples of entity detection within images.

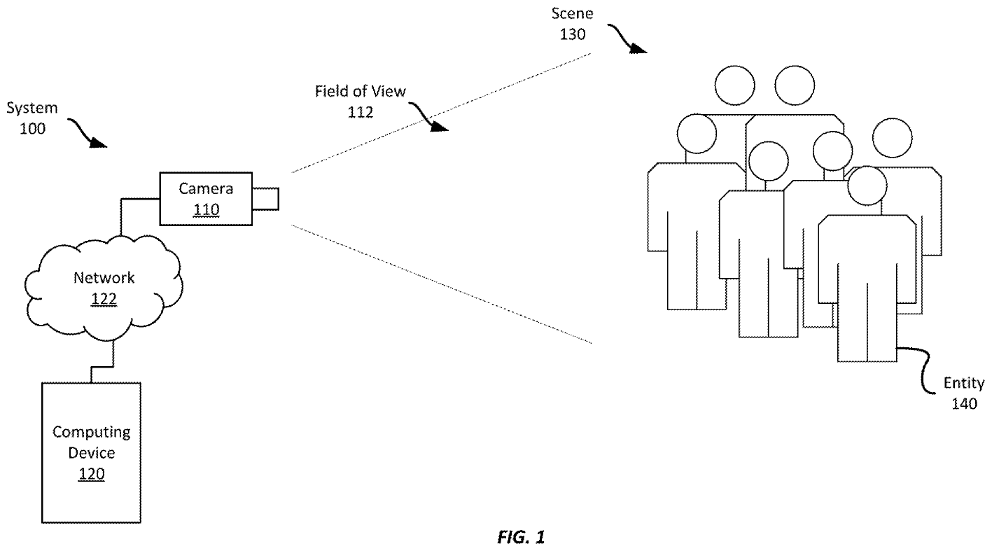

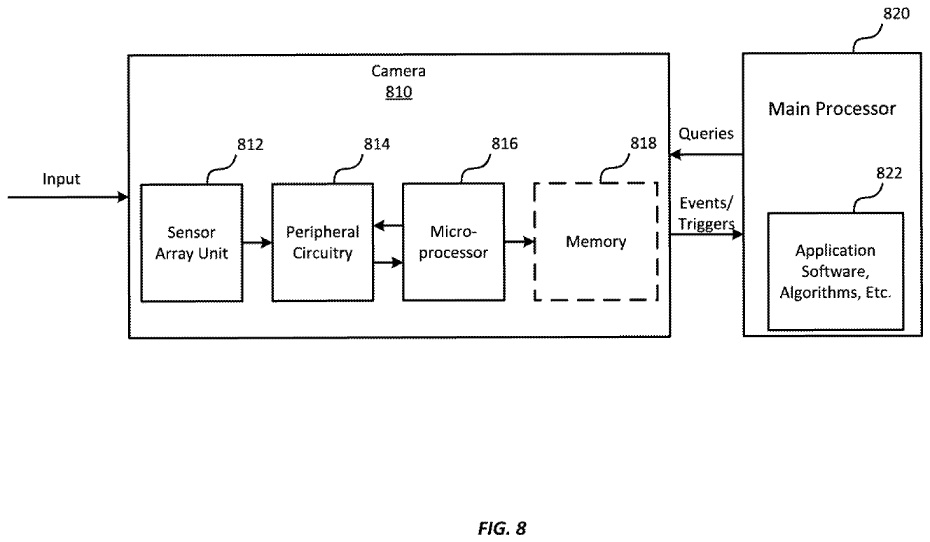

Referring now to FIG. 1, FIG. 1 shows an example system 100 for entity detection within images. The system 100 includes a camera 110 that is communicatively coupled to a computing device 120 via network 122. In this example, the camera 110 is a standalone camera positioned to have a field of view 112 into a scene 130; however, in some examples, the camera 110 may be integrated within the computing device 120. Further, in some examples, the camera may be attached to a wearable device, such as an augmented reality (“AR”) or virtual reality (“VR”) headset, which may include computing device 120 or may be in communication with a computing device 120. Further any suitable means for capturing images may be employed, including digital cameras, image sensors, or low-power cameras (such as the example discussed below with respect to FIG. 8).

In operation, the camera 110 captures one or more images of a scene 130 within the camera's field of view 112, which in this example has multiple entities 140 within it. The captured images are transmitted to the computing device 120 using the network 122. The network 122 may be any suitable communications network or combination of communications networks, e.g., the Internet, whether wired or wireless or a combination of the two, such as Ethernet, universal serial bus (“USB”), cellular (e.g., GSM, GPRS, UMTS, 3G, 4G, LTE, 5G, etc.), WiFi, Bluetooth (“BT”), BT low-energy (“BLE”), etc. Further, as discussed above, the camera 110 may be integrated within the computing device 120, and thus may directly communicate with the computing device, e.g., via a processor within the computing device 120 or with memory within the computing device 120.

The captured images may be stored in memory within the computing device 120 and later processed to detect entities within the images, or in some examples the captured images may be processed in real-time as they are received (though they may be stored as well). The computing device 120 may output information indicating the presence of the entities within the images, such as annotated images identifying the entities within the image, a count of the entities within one or more of the images, etc.

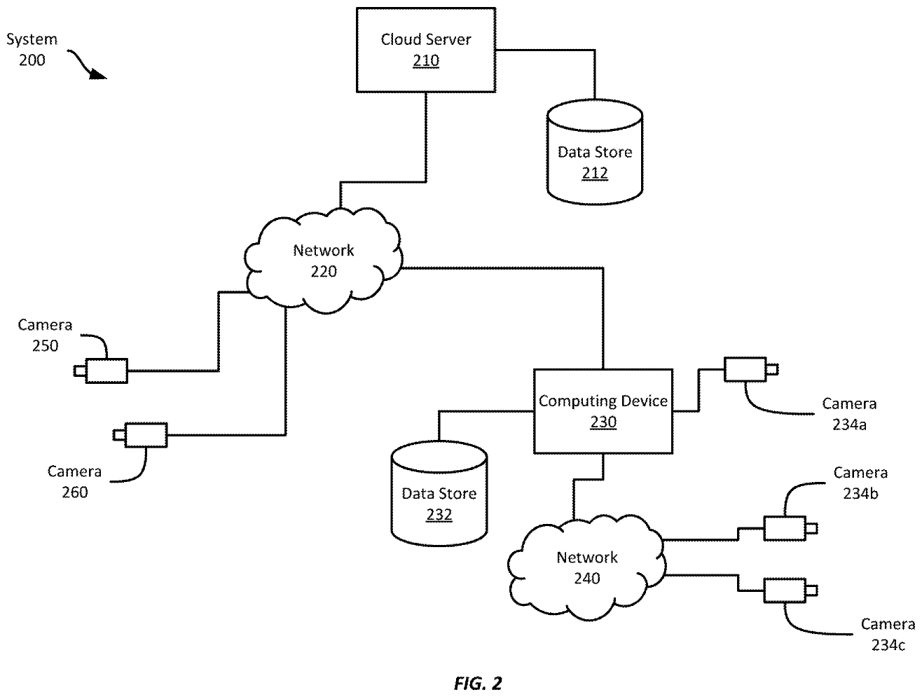

Referring now to FIG. 2, FIG. 2 shows an example system 200 for entity detection within images. The example system 200 includes a computing device 230 that is connected to three cameras 234a-c. One camera 234a is connected via a direct connection, e.g., the camera is incorporated into the computing device 230, while two cameras 234b-c are connected to the computing device 230 via a network 240. In this example, network 240 is a WiFi network, but in some examples may be any suitable wired or wireless communications network or networks as discussed above with respect to FIG. 1. The computing device 230 has an associated data store 232 and is connected to a cloud server 210 via network 220, which may be any suitable wired or wireless communications network or networks as discussed with respect to FIG. 1. In addition, two cameras 240, 250 are in communication with the cloud server 210 via network 220. The cloud server 210 is further in communication with a data store 212.

In this example, the computing device 230 receives video signals from cameras 234a-c and stores the respective videos on a memory device, such as in data store 232. The computing device 230 may then process the received images to detect entities within the images. In this example, the computing device 230 processes the received video by sampling images from the respective videos and detecting entities within the sampled images. Information about the detected entities may be stored locally at the computing device 230, e.g., in data store 232, or may be communicated to the cloud server 210, which may store the information in its data store 212. In some examples, the computing device 230 may forward the videos to the cloud server 210 to perform entity detection, rather than the computing device 230 itself performing entity detection. The cloud server 210 may then provide entity information to the computing device 230 or the entity information may be stored by the cloud server 210, such as in data store 212.

As discussed above, cameras 240 and 250 are connected to the cloud server 210 and transmit video signals to the cloud server 210 via network 220 for entity detection. The cloud server 210 then receives the incoming video signals and samples images from the respective video signals and performs entity detection according to examples discussed herein. Information about the detected entities may then be stored in data store 212.

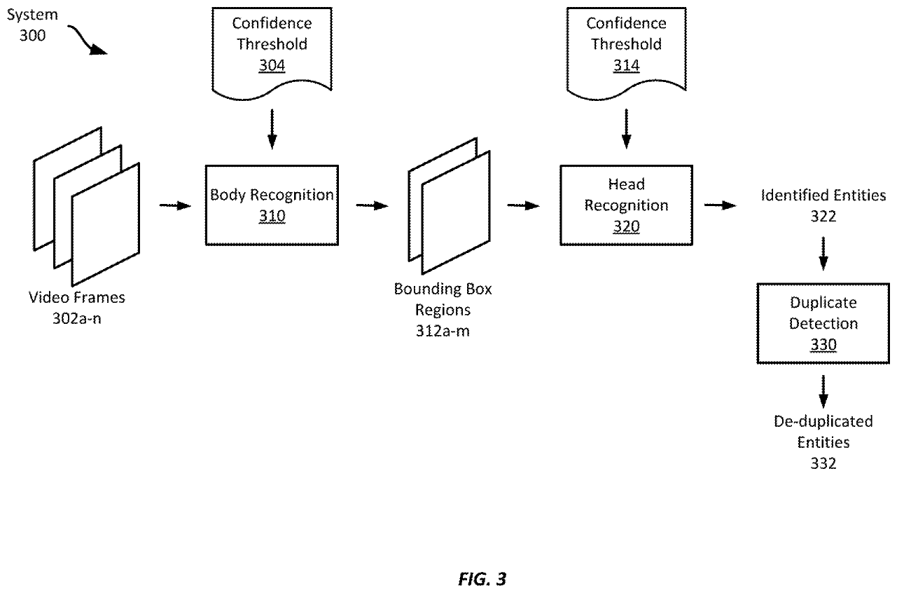

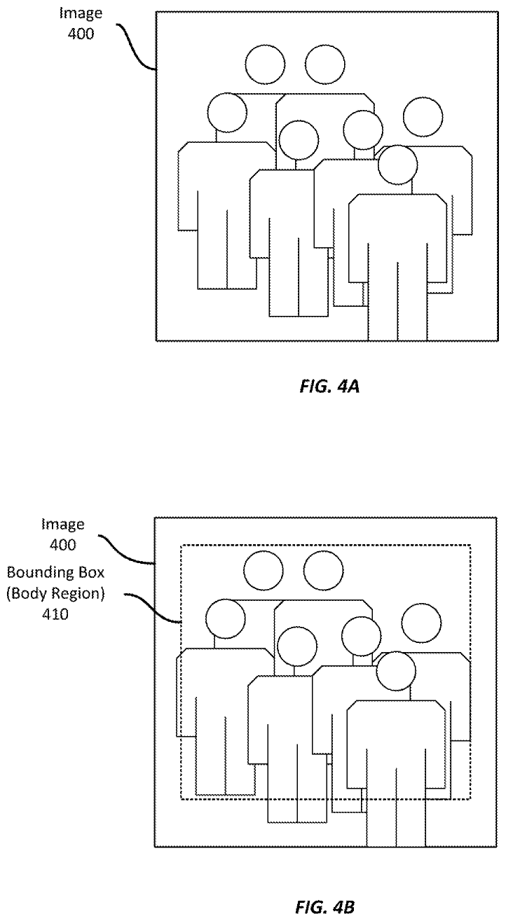

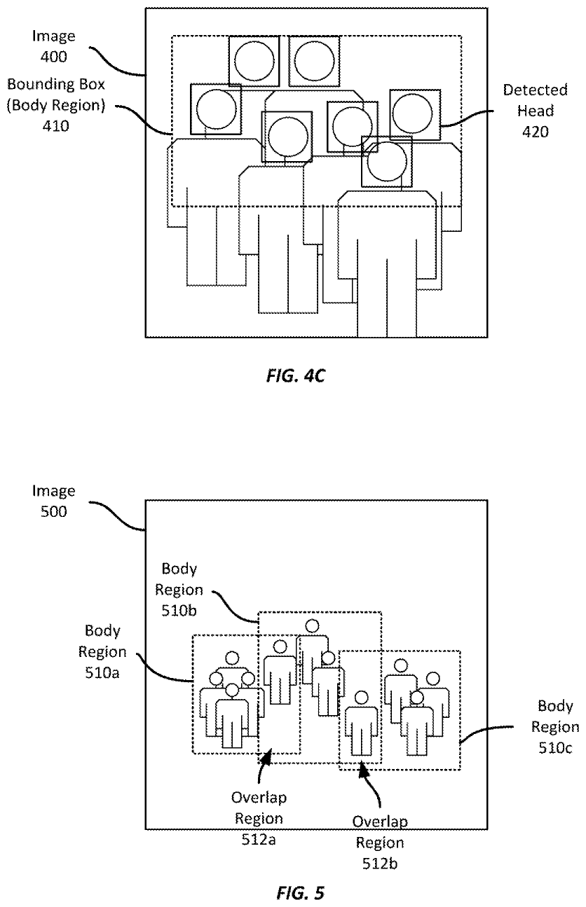

Referring now to FIG. 3, FIG. 3 shows an example system 300 for entity detection within images. In this example, the system 300 includes software executed by one or more computing devices and depicts the processing and movement of data through the system 300. At the left of the system 300, video frames 302a-n (‘n’≥‘a’) captured by a camera, e.g., camera 110, are provided to a body recognition algorithm 310. Each video frame 302a-n in this example is an image and may be processed individually by the body recognition algorithm 310. It should be appreciated, however, that not every image 302a-n may be processed. Instead, the system 300 may sample the images, e.g., at a predetermined rate or after an occurrence of an event. Thus, only some of the images 302a-n may be processed by the system 300. During the description of FIG. 3, reference will be made to FIGS. 4A-4C and 5 to illustrate processing that occurs.

The body recognition algorithm 310 in this example is a trained recognition algorithm, such as a convolutional neural network (“CNN”), e.g. an inception neural network, a residual neural network (“Resnet”), or a recurrent neural network, e.g., long short-term memory (“LSTM”) models or gated recurrent units (“GRUs”) models. The body recognition algorithm 310 can also be any other suitable machine-learning (“ML”) model trained to recognize entity bodies within video frames, such as a three-dimensional CNN (“3DCNN”), a dynamic time warping (“DTW”) algorithm, a hidden Markov model (“HMM”), etc., or combinations of one or more of such algorithms e.g., CNN-HMM or MCNN (Multi-Scale Convolutional Neural Network). In some examples, the body recognition algorithm may be a non-neural-network computer vision (“CV”) algorithm, and instead may be include any known algorithm to detect entity bodies within an image or portion of an image. Any of these body recognition algorithms may be a means for detecting one or more bodies within an image according to different examples, and may further be a means for detecting one or more bodies within a selected portion of an image, as discussed in more detail below.

The body recognition algorithm 310 receives an input image, e.g., image 400 shown in FIG. 4A, and attempts to recognize one or more entity bodies within the image, according to a confidence threshold 304. The confidence threshold 304 may be used to tune the body recognition algorithm 310 to be more or less strict regarding whether a feature within an image 400 is identified as an entity body or not. A confidence threshold of 100% would result in very few if any bodies being identified in an image, even if multiple entity bodies were actually present, while a confidence threshold of 0% would result in a large number of entity bodies being identified, even if none are actually present in the image. Thus, a confidence threshold 304 may be set between these two bounds, e.g., at 75%, and may be adjusted to achieve a desirable rate of entity body detection with an acceptable number of false positives. As discussed above, some false positives at this stage of processing may be acceptable to ensure that all bodies within the image are identified rather than risking excluding some.

While the confidence thresholds discussed above were in terms of percentages, it should be appreciated that a confidence threshold need not be represented by a percentage value. In some examples, a confidence threshold may be represented by a score based on features identified within the image and accumulated during the recognition analysis. Still further confidence thresholds may be specified according to the particular recognition algorithm employed.

After the body recognition algorithm 310 identifies one or more entity bodies within the image, one or more bounding box regions 312a-m (‘m’≥‘a’) are generated to bound regions containing the recognized entity bodies. In this example, the input image 400 is shown in FIG. 4A. As can be seen in FIG. 4A, the image 400 includes a number of different people. To generate bounding boxes, regions containing recognized entities may be determined based on the coordinate positions of those recognized entities within the image. FIG. 4B illustrates a bounding box 410 the encompasses the entities in the image 400. It should be appreciated that while rectangular bounding boxes are determined in this example, any suitable regions may be identified. Such regions need not be rectangular, but instead may have any suitable shape, e.g., circular, hexagonal, triangular, etc. Further, any suitable means for determining one or more regions within an image based on detected bodies within the image, include the algorithms discussed above, may be employed.

The bounding box regions 312a-m are then provided to a head recognition algorithm 330, which recognizes heads within the bounding box region(s) 312a-m. The head recognition algorithm 320 may include any suitable trained head recognition algorithm, such as a convolutional neural network (“CNN”), e.g. an inception neural network, a residual neural network (“Resnet”), or a recurrent neural network, e.g., long short-term memory (“LSTM”) models or gated recurrent units (“GRUs”) models. The head recognition algorithm 320 can also be any other suitable machine-learning (“ML”) model trained to recognize entity bodies within video frames, such as a three-dimensional CNN (“3DCNN”), a dynamic time warping (“DTW”) algorithm, a hidden Markov model (“HMM”), etc., or combinations of one or more of such algorithms—e.g., CNN-HMM or MCNN (Multi-Scale Convolutional Neural Network).). In some examples, the head recognition algorithm may be a non-neural-network CV algorithm, and instead may be include any known algorithm to detect heads within a portion of an image. Any of these head recognition algorithms may be a means for detecting one or more heads within an image region according to different examples.

In this example, the head recognition algorithm 320 obtains information from the image 400 within each of the bounding box region(s) 410. For example, the head recognition algorithm 320 may receive the image 400 and information describing the bounding box(es) 410, or it may only receive the image data within the bounding boxes and not the entire image. The head recognition algorithm 320 then attempts to recognize any entity heads 420 within each of the bounding box regions, according to a confidence threshold 314, shown in FIG. 4C. As discussed above with respect to the body recognition algorithm, the confidence threshold 314 may be used to tune the head recognition algorithm 310 to be more or less strict regarding whether a feature within a bounding box region of the image is identified as an entity head or not. As discussed above, by adjusting the threshold, the head recognition algorithm can be more or less permissive in detecting a head.

In this example, because bounding box regions are used for recognition, rather than the entire image, and because the bounding box regions are likely to have heads in them (corresponding to the recognized bodies), a higher threshold 314 than threshold 304 may be used to reduce the chance of false positives. Thus, this example employs a body recognition threshold 304 that allows some false positives, while using a head recognition threshold 314 that is tuned to produce few, if any, false positives. Such a configuration enables highly accurate head detection within the image 400. After the head recognition algorithm 320 completes its analysis, a number of determined entities 322 are output.

The system 300 also includes duplicate detection 330 to eliminate duplicate detected heads within an image, such as the image 500 illustrated in

FIG. 5. In this example, information about the determined entities 322 is provided to duplicate detection 330, which determines locations of detected heads within the image 500 and eliminates any heads that are apparently duplicates, such as based on having the same location within the image. Duplicate detection 330 may be employed in the event that one or more bounding boxes overlap with another bounding box, illustrated by overlap regions 512a-b in FIG. 5. In such a case, heads detected in the overlap region(s) 512a-b in one bounding box may also be detected in the overlap region 512a-b in another bounding box. Thus, heads detected at the same location, e.g., same pixel coordinates or within a threshold distance from each other, within the overlapping regions 512a-b are likely duplicates. Duplicate detection 330 may, in some examples, only analyze overlap regions 512a-b within each analyzed bounding box rather than analyzing every head in the image to reduce computational burdens on the system 300. Further, if there are no overlapping regions 512a-b within the image, then the system 300 may skip the duplicate detection processing 330 for the particular image.

Duplicate detection 330 then outputs a set of de-duplicated entities 332 in this example, such as the coordinate locations of the identified unique heads within the image 500; however, in some examples, it may output an identification of duplicate heads or locations of identified duplicate heads. The output from duplicate detection 330 may then be used for any suitable purpose, such as to count the unique heads in the image.

Means for determining entities within one or more regions within an image based on identified heads may include head recognition algorithms or may include duplicate detection algorithms. For example, a means for determining entities may receive candidate entities from a means for identifying one or more heads within a region and may perform duplicate detection to eliminate duplicate detected heads. The means for determining entities may then identify the deduplicated detected heads as being determined entities within an image. Alternatively, in some examples, the means for determining entities may include or be in communication with a discrete means for detecting or eliminating duplicate detected heads within an image. In such an example, the means for determining entities may receive a set of deduplicated entities from a means for eliminating duplicated detected heads and generate an output representative of detected entities corresponding to the detected heads. In some examples, the means for determining entities may include or be in communication with a means for counting entities. A means for counting entities may receive deduplicated entity information and may increment a counter for each deduplicated entity to count the total number of entities within an image or a regions of an image.

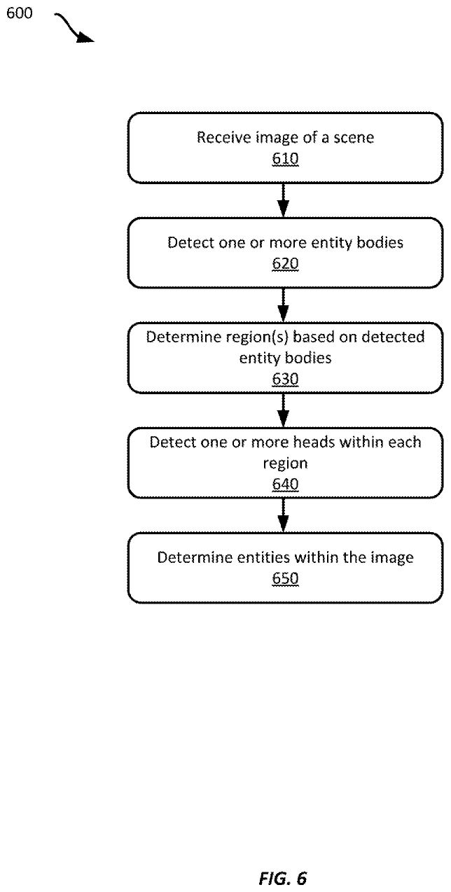

Referring now to FIG. 6, FIG. 6 shows an example method 600 for entity detection within images. The method 600 will be discussed with respect to the system 300 shown in FIG. 3 and the images shown in FIGS. 4A-4C; however, any suitable system may be employed according to this disclosure.

At block 610, the system 300 receives an image 400 of a scene. As discussed above, images may be supplied to the system 300 from a video camera, e.g., camera 110 shown in FIG. 1, or may be obtained from a discrete image captured by a camera, such as within a smartphone or a handheld camera, e.g., a digital single-lens reflex (“DSLR”) camera. Further, in some examples employing video cameras, the system 300 may receive every video frame captured by the video camera. However, in some examples, the system 300 may sample a subset of the video frames. For example, the system 300 may sample the video once per second or once per minute or after an event is detected, depending on particular application or operational requirements.

Further, depending on the processing power of the computing device(s) executing the system 300, the system 300 may require an extended period of time to perform entity detection, e.g., it may be performed in the background using otherwise unused processor cycles. In some such examples, the system 300 may wait until entity detection is completed until a new image is accessed. Such a new image may be an image sampled at a sample rate from a video feed and stored for later processing, or the system 300 may wait until processing of the prior image is complete before sampling a new image.

At block 620, the system 300 detects one or more entity bodies within the image 300. As discussed above with respect to FIG. 3, the system 300 employs a trained body recognition algorithm 310 to detect entity bodies within the image 300 according to a detection threshold 304. In this example, the image 300 includes one or more people, however, the body recognition algorithm 310 may be trained to recognize any entity bodies, such as livestock, e.g., cows, sheep, goats, chickens, etc., other animals, e.g., dogs, cats, birds, etc., vehicles, e.g., cars, trucks, aircraft, etc.

After receiving the image 300 to be processed, the body recognition algorithm 310 processes the image to identify entity bodies within the image. For example, the body recognition algorithm 310 performs its recognition on pixels within the image to identify candidate entity bodies. A confidence or score generated by the body recognition algorithm 310 and associated with each candidate entity body is then compared against the confidence threshold 304 and if the confidence or score satisfies the confidence threshold 304, e.g., the confidence or score meets or exceeds a threshold percentage or score, the candidate entity body is confirmed as a recognized entity body. However, if the confidence or score does not satisfy the confidence threshold 304, the candidate body is rejected.

At block 630, the system 300 determines one or more regions based on the recognized entity bodies. The regions may be defined as one or more bounding boxes encompassing regions within the image containing one or more recognized bodies, generally as described above with respect to FIG. 3. And while bounding boxes are one technique to identify regions, any other suitable technique may be employed. Further, the identified regions need not be rectangular, but instead may be any suitable shape according to the selected technique. In some examples, bounding boxes may be generated to avoid overlaps with previously generated bounding boxes. For example, after generating a bounding box, subsequently generated bounding box may be prohibited from enclosing regions already enclosed by previously generated bounding boxes. In some such examples, bounding boxes may abut other bounding boxes, but they do not overlap.

At block 640, the system 300 detects one or more heads within each region determined at block 630 using a trained head recognition algorithm 320, generally as discussed above with respect to FIG. 3. The head recognition algorithm 320 is trained to recognize heads that correspond with the bodies recognized by the trained body recognition algorithm 310, though in some examples both algorithms 310, 320 may be trained to recognize multiple different types of entity bodies or heads. Further, some examples may be trained to detect entities such as vehicles. Thus, the head recognition algorithm 320 may in fact be trained to recognize characteristics of a vehicle, such as a headlight or a windshield or window of a vehicle.

Similarly to the processing at block 620, the trained head recognition algorithm generates a confidence or score associated with each candidate entity head, which is then compared against a confidence threshold 314 and if the confidence or score satisfies the confidence threshold 314, the candidate entity head is confirmed as a recognized entity head. However, if the confidence or score does not satisfy the confidence threshold 314, the candidate head is rejected.

At block 650, the system 300 determines entities within the image 300. As discussed above with respect to FIGS. 3 and 5, in some examples, the system 300 may employ regions that overlap with each other, e.g., overlap regions 512a-b, after block 630. The system 300 may then employ duplicate detection 330. However, if no overlapping regions are employed, duplicate detection may be omitted.

After duplicate detection processing is completed, if needed, the system then outputs entity information associated with the determined entities within the image 300. For example, the system 300 may output a count of determined entities or it may output information identifying locations of the detected heads or entities within the image, e.g., (x, y) coordinates of the center/centroid of each detected head within the image. In some examples, the system 300 may annotate the image such as by placing an ‘x’ or ‘+’ over each detected head or entity, or providing an outline around each detected head or entity. In some examples, other information may be annotated on the image, such as a confidence or score associated with a respective detected head. Further, while annotations may be provided graphically within the image itself, in some examples, metadata may be added to the image to provide such information as discussed above or stored separately from the image, such as in a metadata file or in one or more database records generated to store the entity information or associate the entity information with the image.

After processing at block 650 has completed, the method 600 may return to block 610 to process another image. It should be appreciated that the method 600 steps may be performed in any suitable order. For example, blocks 620-650 may be performed iteratively within the context of a single image. For example, the body recognition algorithm may execute and identify one or more bodies within a predefined region of the image, such as in a first quadrant of the image, and a bounding box (or multiple bounding boxes) may be generated around a portion the quadrant that includes one or more detected bodies. The region may then be processed by the head recognition algorithm at block 640 and determines entities may be identified at block 650. The processing may then return to block 620 to process another quadrant of the image. Further, such processing may be performed in parallel by different computing devices, which may allow subdividing the processing of individual images or a stream of video images.

Subdividing the image into different regions for processing may be performed by a means for iteratively selecting a portion of an image to process. Such a means may divide the image into two or more different regions, e.g., four quadrants, a 3×3 grid, etc. The means for iteratively selecting a portion of the image may then provide each selected portion of the image for processing, such as discussed above with respect to FIG. 6.

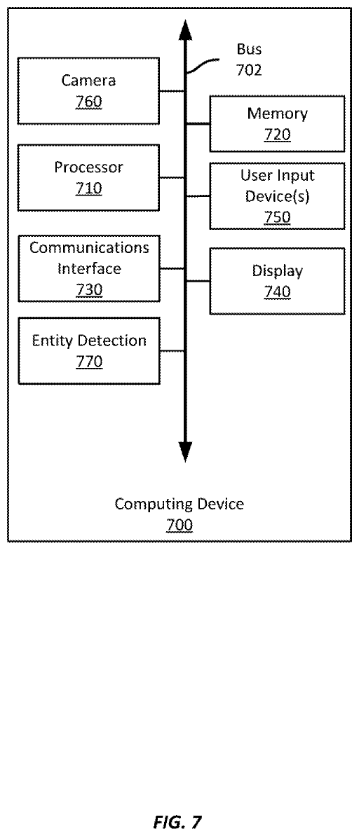

Referring now to FIG. 7, FIG. 7 illustrates shows an example computing device 700 suitable for use in example systems or methods for entity detection within images according to this disclosure. For example, computing devices 120 and 230 shown in FIGS. 1 and 2, respectively, may be configured based on the example computing device 700 shown in FIG. 7. The example computing device 700 includes a processor 710 which is in communication with the memory 720 and other components of the computing device 700 using one or more communications buses 702. The processor 710 is configured to execute processor-executable instructions stored in the memory 720 to perform one or more methods for entity detection within images according to different examples, such as part or all of the example method 600 described above with respect to FIG. 6. The computing device, in this example, also includes one or more user input devices 750, such as a keyboard, mouse, touchscreen, microphone, camera (e.g., to enable gesture inputs), etc., to accept user input. The computing device 700 also includes a display 740 to provide visual output to a user.

Example computing devices may have any suitable form factor. For example, suitable computing devices include desktop computers and laptop computers. In some examples, the computing device may be integrated within or in communication with a wearable device, such as an AR or VR headset, which in turn may include one or more cameras. Other examples include handheld computing devices such as smartphones, tablets, and phablets. Some example computing devices may be integrated within a camera device, such as a hand-held digital single-lens-reflex (“DSLR”) camera, a hand-held video camera, a security camera, an occupancy sensing camera or system, a doorbell camera, etc. Further, and as discussed above with respect to FIG. 2, computing devices according to this disclosure may be in communication with other computing devices, such as the computing device 230 in FIG. 2 that is in communication with cloud server 210. Similarly, if one or more of cameras 234a-c, 250, or 260 has an integrated computing device, such an integrated computing device may communicate with other computing devices, such as computing device 230 or cloud server 210.

The computing device 700 also includes a communications interface 740. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Such networks may include BT or BLE, WiFi, cellular or other WWANs (including 3G/4G/5G cellular), NB-IoT, CIoT, Ethernet, USB, Firewire, and others, such as those discussed above with respect to FIG. 1. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP. Such a communications interface may be a means for receiving an image of a scene. For example, as shown and described with respect to FIG. 1, a camera 110 may capture images and transmit them to a computing device 120 via a network 122. Thus, a communications interface 630 may enable receipt of such images from a camera. In examples where the computing device 700 includes a camera 760, bus 702 or the processor 710 may be a means for receiving an image of a scene.

The computing device also includes a camera 760 and entity detection system 770. The camera 760 may be any suitable camera or image sensor and may be configured to supply video to the computing device or it may be used to capture discrete images, depending on a particular mode of operation. Further, it should be appreciated, that the camera 760 is optional and may be part of some example computing devices according to this disclosure or may be separate from the computing device, such as shown in FIGS. 1 and 2. Further, in some examples, the camera may include a low-power device, such as the example described in more detail with respect to FIG. 8 below.

Entity detection system 770 includes processor-executable instructions configured to cause the processor 710 to perform processing and methods disclosed herein. For example, entity detection system 770 may be configured as an example system 300 described above with respect to FIG. 3. Further, entity detection system 770 may be configured according to the example method 500 discussed above with respect to FIG. 5. In still other examples, entity detection system 770 may be configured according to any suitable example according to this disclosure.

It should be appreciated that all aspects of the computing device shown in FIG. 7 are not required in every example. For example, a suitable computing device 700 may be a server in a cloud computing environment, e.g., cloud server 210 shown in FIG. 2, that lacks a display 740, a camera 760, and user interface devices 750.

Referring now to FIG. 8, FIG. 8 illustrates an example of a camera 810, which is another example means for capturing images, suitable for use with examples according to this disclosure. In this example, the camera 810 makes up a sensing system that can perform aspects of entity detection discussed above. Thus, the camera 810 may form a special-purpose camera that includes certain pixel-level computer vision functionality. Further, in this example, the camera 810 is a low power camera (“low power” referring to electrical power consumption, rather than computational power) that may remain active even if other portions of the computing device are in a sleep or standby mode.

Examples of the camera 810 may or may not include peripheral circuitry 214, a microprocessor 216, and/or memory 218. Additionally or alternatively, examples may combine, separate, add, omit, and/or rearrange the components of FIG. 8, depending on desired functionality. For example, where the camera 810 comprises a sensor array (e.g., a pixel array), some optics may be utilized to manipulate the input (e.g., light) before it reaches the sensor array.

As illustrated in FIG. 8, a camera 810 receiving an input can comprise a sensor array unit 812, peripheral circuitry 814, microprocessor 816, and/or memory 818. The camera 810 can be communicatively coupled through either a wired or wireless connection with a main processor 820 of an electronic device, such as the example computing device 700 shown in FIG. 7, which can provide queries to the camera 810 and receive events and/or other triggers from the camera 810. In some embodiments the main processor 820 may simply correspond to a larger (e.g., greater in processing power and/or greater in electric power use) processing unit than the microprocessor 816. In some implementations, microprocessor 816 can correspond to a dedicated microprocessor or a first processing unit and can be configured to consume less electrical power than the main processor 820, which can correspond to a second processing unit. In various embodiments, functionality may be distributed in various ways across the microprocessor 816 and the main processor 820.

The type of sensor array unit 812 utilized can vary, depending on the desired functionality of the electronic sensor. As previously indicated, a sensor array unit 812 can include an array (e.g., a two-dimensional array) of sensor cells for sensing visual. For example, the sensor array unit 812 can comprise a camera sensor or other vision and/or sensor array where the plurality of sensor cells forms a grid of pixels.

In some embodiments, the sensor array unit 812 may include a “smart” array, that includes some additional memory and/or logic circuitry with which operations on one or more outputs of the sensor cells may be performed. In some embodiments, each sensor pixel in the sensor array may be coupled with the memory and/or logic circuitry, which may or may not be part of the peripheral circuitry 814 (discussed in more detail below). The output of the sensor array unit 812 and/or peripheral circuitry may include outputs in addition or as an alternative to the raw sensor readings of the sensor cells. For example, in some embodiments, the sensor array unit 812 and/or peripheral circuitry can include dedicated CV computation hardware configured to receive image data from a sensor array of the sensor array unit 812 comprising more than one sensor pixel. CV features can then be computed or extracted by the dedicated CV computation hardware using readings from neighboring sensor pixels of the sensor array, providing outputs such as a computed HSG and/or an LBP feature, label, or descriptor. In some embodiments, no image signal processing circuitry may be disposed between the sensor array unit 812 and the dedicated CV computation hardware. Put differently, dedicated CV computation hardware may receive raw sensor data from the sensor array unit 812 before any image signal processing is performed on the raw sensor data. Other CV computations are also possible based on other CV computation algorithms including body detection, body region determination, or head detection, such as discussed above with respect to FIG. 3.

The synchronicity (or asynchronicity) of the sensor array unit 812 may also depend on desired functionality. In some embodiments, for example, the sensor array unit 812 may comprise a traditional (i.e., “frame-based”) camera with readout circuitry timed to provide periodic sampling of each pixel based on certain timing requirements. In some embodiments, the sensor array unit 812 may comprise an event-driven array by which sensor output may be determined by when a sensor reading or other output reaches a certain threshold and/or changes by a certain threshold, rather than (or in addition to) adhering to a particular sampling rate. For a “smart” array, as discussed above, the sensor reading or other output could include the output of the additional memory and/or logic (e.g., an HSG or LBP output from a smart sensor array). In one embodiment, a smart sensor array can comprise a dynamic vision sensor (DVS) in which, for each pixel in the smart sensor array, a pixel value is asynchronously output when the value changes from a previous value by a threshold amount. In some implementations, the sensor array unit 812 can be a hybrid frame-event-driven array that reads values out at a given frame rate, but saves electrical power by only reading out values for elements in the array that have changed since the previous read-out.

The peripheral circuitry 814 can also vary, depending on the desired functionality of the electronic sensor. The peripheral circuitry 814 can be configured to receive information from the sensor array unit 812. In some embodiments, the peripheral circuitry 814 may receive information from some or all pixels within the sensor array unit 812, some or all of the in-pixel circuitry of the sensor array unit 812 (in implementations with significant in-pixel circuitry), or both. In embodiments where the sensor array unit 812 provides a synchronized output, for example, peripheral circuitry 814 can provide timing and/or control operations on the sensor array unit output (e.g., execute frame-based and/or similar timing). Other functionality provided by the peripheral circuitry 214 can include an event-queuing and/or processing operation, analog processing, analog-to-digital conversion, an integration operation (e.g. a one- or two-dimensional integration of pixel values), body detection, body region determination, head detection, CV feature computation, object classification (for example, cascade-classifier-based classification or histogram-based classification), or histogram operation, memory buffering, or any combination thereof, “pixel block value summation,” “neighboring pixel value comparison and thresholding,” “vector dot product computation,” and the like. Means for performing such functionality, e.g., body detection, body region determination, or head detection, can include, for example, peripheral circuitry 814, in various implementations. In some embodiments, the peripheral circuitry 814 is coupled to the sensor cell outputs of the sensor array unit 812 and does not include a microprocessor or other processing unit.

In some examples, the camera 810 can further include a microprocessor 816 coupled to the output of the peripheral circuitry 814. The microprocessor 816 generally can comprise a processing unit that operates on relatively low power, relative to the main processor 820. In some implementations, the microprocessor 816 can further execute computer vision and/or machine-learning algorithms, e.g., body detection, body region determination, or head detection, (which can be frame- and/or event-based) using its own program (for example, software-based) and data memory. Thus, the microprocessor 816 is able to perform computer vision and/or machine learning functions based on input received by the sensor array unit 812 while the main processor 820 operates in a low-power mode. When the microprocessor 816 determines that an event requiring output to the main processor 820 has taken place, the microprocessor 816 can communicate an event to the main processor 820, which can bring the main processor 820 out of its low-power mode and into a normal operating mode.

Optionally, in some embodiments, the output of the microprocessor 816 may further be provided to memory 818 before being relayed to the main processor 820. In some implementations, memory 818 may be shared between microprocessor 816 and main processor 820. The memory 818 may include working memory and/or data structures maintained by the microprocessor 816 on the basis of which events or triggers are sent to the main processor 820. Memory may be utilized, for example, in storing images, tracking detected objects, and/or performing other operations. Additionally or alternatively, memory 818 can include information that the main processor 820 may query from the camera 810. The main processor 820 can execute application software, algorithms, etc. 822, some of which may further utilize information received from the camera 810.

As previously noted, the ability of the camera 810 to perform certain functions, such as image processing and/or computer vision functions, independent of the main processor 820 can provide for vast power, speed, and memory savings in an electronic device that would otherwise have to utilize the main processor 820 to perform some or all of the functions of the camera 810. In particular, the combination, of the sensor array unit 812, peripheral circuitry 814, and microprocessor 816 allow scene understanding that is capable of detecting, in a dynamically changing scene captured by the image array, an occurrence.

In one example, computing device employing the configuration shown in FIG. 8 can perform entity detection and may update entity detection upon detecting changes in pixel values, e.g., of a threshold number of pixels. In this example, the computing device enters into a standby mode in which the main processor 820 operates on a low-power sleep mode. However, the camera 810 with an image array as the sensor array unit 812 continues to operate, processing data from the sensor array unit 812 as objects enter and exit the image array's field of view. When changes in the field of view of the image array (e.g., when one or more people enter into the field of view), it may be detected by the sensor array unit 812, the peripheral circuitry 814, the microprocessor 816, or any combination thereof. which may then perform body detection, body region determination, and head detection, such as described above with respect to FIG. 3. The microprocessor 816 can then send determined entity information to the main processor 820, which can then reactivate to store the entity information or provide it to a cloud system, such as cloud server 210 shown in FIG. 2. Further, in some examples, the camera may only provide body detection and body region determination. Upon detecting one or more bodies entering the field of view, the camera 810 may provide a captured image and identified body regions to the main processor 820, which may then perform head detection and identify entities within the image, generally as discussed above with respect to FIGS. 3 and 6.

Thus, as described with respect to FIG. 8, example cameras 810 according to this disclosure may include one or more of means for receiving an image of a scene (e.g., sensor array unit 812), means for detecting one or more bodies within an image, means for determining one or more regions within the image based on the one or more bodies, and means for identifying one or more heads within the determined regions. Such example cameras may provide low power operation while allowing a main processor 820 within a computing device, e.g., computing device 700, to remain in a sleep mode or to perform other activities while the camera 810 itself performs aspects of entity detection according to this disclosure.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices or systems-on-a-chip and may include devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method comprising:
receiving an image of a scene;
detecting one or more bodies within the image;
determining one or more regions within the image based on the detected one or more bodies;
detecting one or more heads within the one or more regions; and
determining entities within the one or more regions based on the detected one or more heads.

2. The method of claim 1, further comprising, iteratively, until the image has been fully processed:
selecting a portion of the image;
detecting bodies within the selected portion of the image;
determining one or more regions within the selected portion of the image based on the detected bodies;
detecting one or more heads within the one or more regions; and
identifying entities within the one or more regions based on the detected one or more heads; and
determining entities within the image based on the determined entities within the regions.

3. The method of claim 1, further comprising sampling images from a video feed at a predetermined sampling rate.

4. The method of claim 1, further comprising eliminating duplicate detected heads.

5. The method of claim 1, wherein one or more of (i) the detecting one or more bodies within the image, (ii) determining one or more regions within the image, or (iii) detecting one or more heads is performed by a camera.

6. The method of claim 1, further comprising outputting a number of determined entities within the image.

7. The method of claim 1, wherein the detecting the one or more bodies is based on a first confidence threshold and identifying the one or more heads is based on a second confidence threshold, the first confidence threshold lower than the second confidence threshold.

8. A device comprising:
a non-transitory computer-readable medium; and
a processor communicatively coupled to the non-transitory computer-readable medium and configured to execute processor-executable instructions stored in the non-transitory computer-readable medium, the processor-executable instructions configured to cause the processor to:
receive an image of a scene;
detect one or more bodies within the image;
determine one or more regions within the image based on the detected one or more bodies;
detect one or more heads within the one or more region; and
determine entities within the one or more regions based on the detected one or more heads.

9. The device of claim 8, wherein the processor-executable instructions are further configured to cause the processor to, iteratively, until the entire image is processed:
select a portion of the image;
detect bodies within the selected portion of the image;
determine one or more regions within the selected portion of the image based on the detected bodies;
detect one or more heads within the one or more regions; and
identify entities within the one or more regions based on the detected one or more heads; and
determine entities within the image based on the determined entities within the regions.

10. The device of claim 8, wherein the processor-executable instructions are further configured to cause the processor to sample images from a video feed at a predetermined sampling rate.

11. The device of claim 8, wherein the processor-executable instructions are further configured to cause the processor to eliminate duplicate detected heads.

12. The device of claim 8, wherein the entities comprise humans.

13. The device of claim 8, wherein the processor-executable instructions are further configured to cause the processor to output a number of determined entities within the image.

14. The device of claim 8, wherein the processor-executable instructions are further configured to cause the processor to detect the one or more bodies based on a first confidence threshold and identify the one or more heads based on a second confidence threshold, the first confidence threshold lower than the second confidence threshold.

15. The device of claim 8, further comprising a camera, wherein the camera comprises the processor.

16. A non-transitory computer-readable medium comprising processor-executable instructions configured to cause a processor to:
receive an image of a scene;
detect one or more bodies within the image;
determine one or more regions within the image based on the detected one or more bodies;
detect one or more heads within the one or more region; and
determine entities within the one or more regions based on the detected one or more heads.

17. The non-transitory computer-readable medium of claim 16, further comprising processor-executable instructions configured to cause the processor to, iteratively, until the entire image is processed:
select a portion of the image;
detect bodies within the selected portion of the image;
determine one or more regions within the selected portion of the image based on the detected bodies;
detect one or more heads within the one or more regions; and
determine entities within the one or more regions based on the detected one or more heads; and
determine entities within the image based on the determined entities within the regions.

18. The non-transitory computer-readable medium of claim 16, further comprising processor-executable instructions configured to cause the processor to sample images from a video feed at a predetermined sampling rate.

19. The non-transitory computer-readable medium of claim 16, further comprising processor-executable instructions configured to cause the processor to eliminate duplicate detected heads.

20. The non-transitory computer-readable medium of claim 16, wherein the non-transitory computer-readable medium is incorporated within a camera.

21. The non-transitory computer-readable medium of claim 16, further comprising processor-executable instructions to cause the processor to output a number of determined entities within the image.

22. The non-transitory computer-readable medium of claim 16, further comprising processor-executable instructions configured to cause the processor to detect the one or more bodies based on a first confidence threshold and identify the one or more heads based on a second confidence threshold, the first confidence threshold lower than the second confidence threshold.

23. An apparatus comprising:
means for receiving an image of a scene;
means for detecting one or more bodies within the image;
means for determining one or more regions within the image based on the detected one or more bodies;
means for identifying one or more heads within the region; and
means for determining entities within the one or more region based on the identified one or more heads.

24. The apparatus of claim 23, further comprising:
means for iteratively selecting a portion of the image until the entire image is processed; and wherein
the means for detecting bodies is further for detecting bodies within the selected portion of the image;
the means for determining one or more regions is further for determining one or more regions within the selected portion of the image based on the detected bodies;
the means for identifying one or more heads is further for identifying one or more heads within the one or more regions; and
the means for determining entities is further for determining entities within the one or more regions based on the identified one or more heads; and
means for determining entities within the image based on the determined entities within the regions.

25. The apparatus of claim 23, further comprising means for sampling images from a video feed at a predetermined sampling rate.

26. The apparatus of claim 23, further comprising means for eliminating duplicate detected heads.

27. The apparatus of claim 23, wherein the entities comprise humans.

28. The apparatus of claim 23, further comprising means for counting a number of determined entities within the image.

29. The apparatus of claim 23, wherein the means for detecting the one or more bodies is based on a first confidence threshold and means for identifying the one or more heads is based on a second confidence threshold, the first confidence threshold lower than the second confidence threshold.

30. The apparatus of claim 23, further comprising means for capturing images, and wherein the means for capturing images comprises one or more of (i) the means for determining one or more regions within the image based on the detected on or more bodies, (ii) the means for identifying one or more heads within the region, or (iii) the means for determining entities within the one or more region based on the identified one or more heads
